(19) United States
(12) Patent Application Publication
(10) Pub. No.: US 2025/0181017 A1
(43) Pub. Date: Jun. 5, 2025

(54) IMAGE FORMING APPARATUS AND STORAGE MEDIUM

(71) Applicant: Konica Minolta, Inc., Tokyo (JP)

(72) Inventor: Takashi YAMADA, Tokyo (JP)

(21) Appl. No.: 18/944,548

(22) Filed: Nov. 12, 2024

(30) Foreign Application Priority Data
Nov. 30, 2023 (JP) 2023-202439

(51) Int. Cl. G03G 15/00; G03G 15/01

(52) U.S. Cl. CPC G03G 15/5029; G03G 15/0131; G03G 15/0189; G03G 2215/00738

(57) ABSTRACT

Disclosed is an image forming apparatus including: an image creator that creates an image; a transferer that transfers the image created by the image creator onto a recording medium by causing the image and the recording medium to pass through a transfer nip formed by transfer members in a pressure contact state; and a hardware processor that acquires level difference information of a level difference in the recording medium, and changes a pressure contact force of the transfer members in the pressure contact state based on the acquired level difference information.

### CROSS-REFERENCE TO RELATED APPLICATIONS

The entire disclosure of Japanese Patent Application No. 2023-202439, filed on Nov. 30, 2023, is incorporated herein by reference in its entirety.

### BACKGROUND OF THE INVENTION

### Technical Field

The present invention relates to an image forming apparatus and a storage medium.

### Description of Related Art

In a case where there is a level difference in the sheet due to the roll sheet being connected by a tape, the sheet on the seal side of the label sheet being cut out, or the like, a transfer failure may occur when the level difference portion passes through the nip of the transfer section. In addition, the transfer member may be damaged, and an image defect may occur at the time of subsequent transfer.

In order to avoid this, JP 2020506430 A describes that a detection means for detecting the seam is provided on the upstream of sheet conveyance, and the transfer member is separated in accordance with the arrival of the seam.

### SUMMARY OF THE INVENTION

In the technology of JP 2020506430 A, when the seam is detected, the transfer members are separated from each other. However, when the transfer member is separated, it takes time until the transfer is restarted, and productivity decreases. Furthermore, an impact of the separation operation is transmitted to the primary transfer section, causing a transfer deviation, which leads to problems such as a shift in the relationship between the front and rear image positions and generation of waste sheet due to alignment of the image positions.

An object of the present invention is to enable an image forming apparatus to suppress occurrence of damage to a transfer member and a transfer failure while maintaining a pressure contact state of the transfer member in a case where a sheet has a level difference.

To achieve at least one of the abovementioned objects, according to an aspect of the present invention, an image forming apparatus reflecting one aspect of the present invention is an image forming apparatus comprising:
an image creator that creates an image;
a transferer that transfers the image created by the image creator onto a recording medium by causing the image and the recording medium to pass through a transfer nip formed by transfer members in a pressure contact state; and
a hardware processor that acquires level difference information of a level difference in the recording medium, and changes a pressure contact force of the transfer members in the pressure contact state based on the acquired level difference information.

To achieve at least one of the abovementioned objects, according to an aspect of the present invention, an storage medium reflecting one aspect of the present invention is a non-transitory computer-readable storage medium storing a program for a computer of an image forming apparatus including: an image creator that creates an image; and a transferer that transfers the image created by the image creator onto a recording medium by causing the image and the recording medium to pass through a transfer nip formed by transfer members in a pressure contact state, the program causing the computer to acquire level difference information of a level difference in the recording medium, and change a pressure contact force of the transfer members in the pressure contact state based on the acquired level difference information.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram illustrating a schematic configuration of an image forming apparatus;

FIG. 2 is a block diagram illustrating a main functional configuration of an image forming apparatus;

FIG. 3 is a view illustrating an example of a configuration of a secondary transfer section;

FIG. 4 is a view illustrating an example of a configuration of a detection section;

FIG. 5 is a view illustrating another example of a configuration of a detection section;

FIG. 6 is a view illustrating another example of a configuration of a detection section;

FIG. 7 is a flowchart illustrating a flow of transfer control processing executed by a controller of FIG. 2;

FIG. 8 is a view showing a change in the pressure contact state of the transfer members of the secondary transfer section and the level difference in the sheet;

FIG. 9 is a graph which shows the relation among the height of a level difference on the surface of a sheet, the pressure contact force of the transfer members in the secondary transfer section, and continuation/stop of image creation in the transfer control processing in FIG. 7;

FIG. 10 is a diagram for explaining exemplary level difference information;

FIG. 11 is a view for explaining another example of level difference information;

FIG. 12 is a diagram showing post-processing timings in a post-processing apparatus which performs post-processing on the assumption that the cycle of an image has a designated length, and an image creation stop period in modification example 2; and

FIG. 13 is a diagram illustrating post-processing timing in a post-processing apparatus that performs post-processing in accordance with an image position and an image creation stop period in modification example 2.

### DETAILED DESCRIPTION

Hereinafter, one or more embodiments of the present invention will be described with reference to the drawings. However, the scope of the invention is not limited to the disclosed embodiments.

### Configuration of Image Forming Apparatus 100

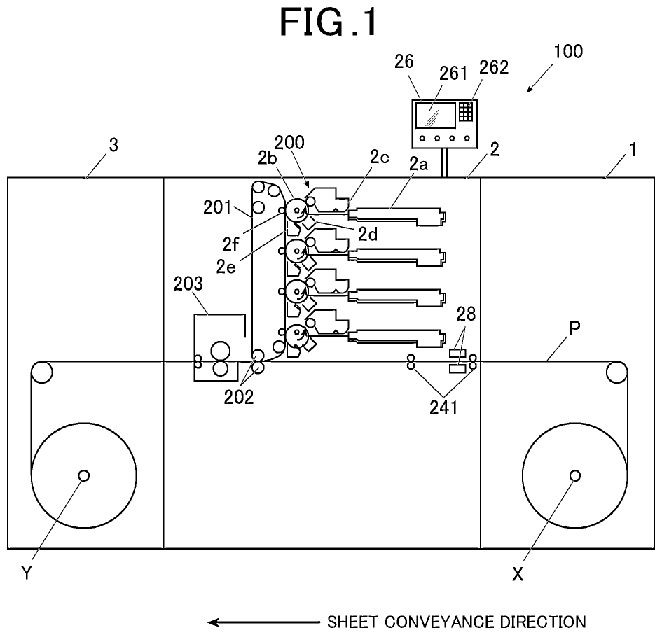

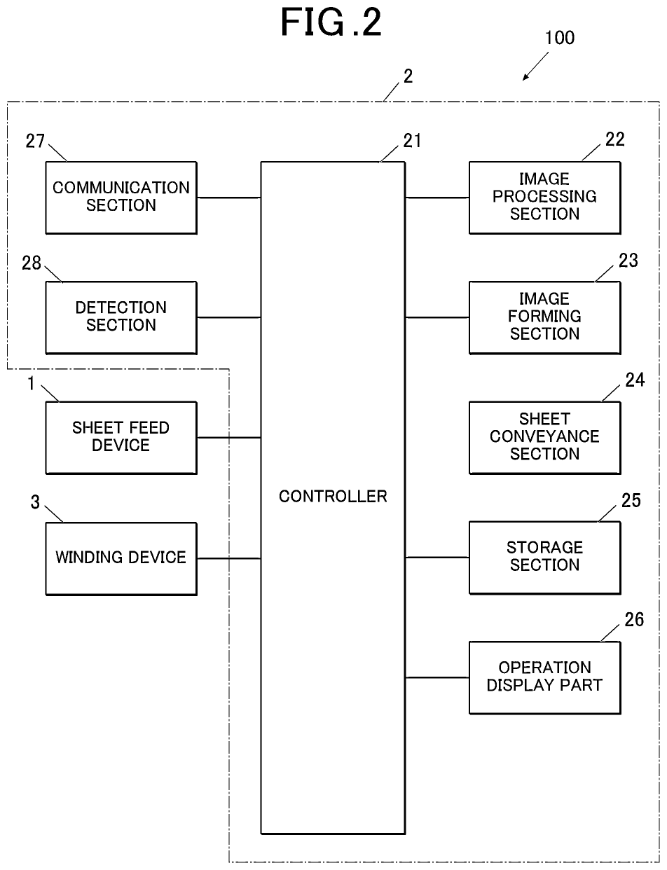

FIG. 1 is a diagram illustrating an overall configuration example of an image forming apparatus 100 according to an embodiment of the present invention as viewed from the front. FIG. 2 is a diagram illustrating a main part of a control system of the image forming apparatus 100. The image forming apparatus 100 is an apparatus that forms an image on a recording medium. The recording medium includes, for example, sheet, film, and cloth. In the present embodiment, a case where an image is formed on a roll-shaped sheet P will be described as an example.

As illustrated in FIG. 1, the image forming apparatus 100 is configured by connection of a sheet feed device 1, a main body section 2, and a winding device 3 from the upstream along a sheet feeding direction (sheet conveyance direction) of a sheet P.

The sheet feed device 1 is a device that feeds a sheet P to the main body section 2. The sheet feed device 1 conveys a sheet P wound around a support shaft X to the main body section 2 at a constant speed via, for example, a plurality of conveyance roller pairs such as a sending roller and a sheet feed roller. A sheet feeding operation of the sheet feed device 1 is controlled by a controller 21 included in the main body section 2.

The main body section 2 performs image formation by an intermediate transfer method utilizing an electrophotographic process technology.

As shown in FIG. 2, the main body section 2 includes a controller 21 (hardware processor), an image processing section 22, an image forming section 23, a sheet conveying section 24, a storage section 25 (storage), an operation display part 26, a communication section 27, a detection section (detector) 28, and the like. Each unit of the main body section 2 is connected by a bus.

The controller 21 includes a central processing unit (CPU), a read only memory (ROM), and an RAM (Random Access Memory) And the like. The CPU of the controller 21 reads a program according to processing contents from the ROM, develops the program in the RAM, and cooperates with the developed program to centrally control an operation of each section of the main body section 2, the sheet feed device 1, the winding device 3, and the like.

The image processing section 22 performs image processing such as density correction processing, rasterization processing, color conversion processing, and halftone processing on image data of a job input via the communication section 27 or the like, and outputs the processed image data to the image forming section 23.

The image forming section 23 includes an image creating section 200 (image creator), an intermediate transfer body 201, a secondary transfer section 202 (transferer), and a fixing section 203. The image creating section 200 includes four sets of an exposure section 2a, a photoreceptor 2b, a developing section 2c, a charging section 2d, a cleaning section 2e, and a primary transfer roller 2f (primary transfer section) corresponding to color components of yellow (Y), magenta (M), cyan (C), and black (K), respectively.

The image forming section 23 first forms toner images of the respective colors on the photoreceptors 2b of the respective colors of the image creating section 200, sequentially performs primary transfer to the intermediate transfer body 201 by the primary transfer rollers 2f, and superimposes the toner images of the four colors. Next, the image forming section 23 conveys the toner image on the intermediate transfer body 201 to the secondary transfer section 202, and secondarily transfers the toner image onto the sheet P fed from the sheet feed device 1, thereby forming an image on the sheet P. Then, the image forming section 23 fixes the formed image on the sheet P by the fixing section 203.

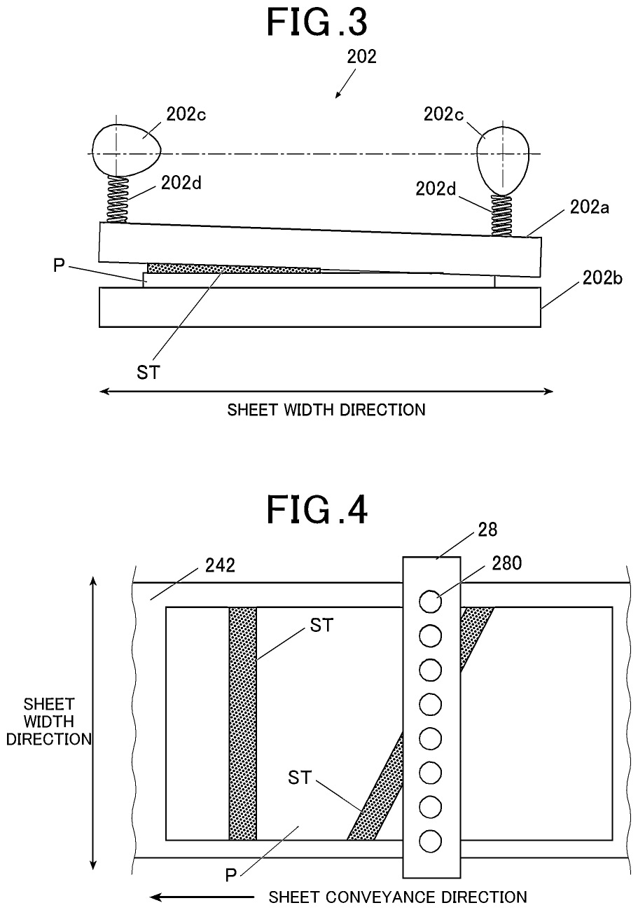

FIG. 3 is a diagram illustrating an example of the secondary transfer section 202 in the present embodiment. The secondary transfer section 202 includes an upper roller 202a and a lower roller 202b as transfer members. The upper roller 202a and the lower roller 202b can be pressed against and separated from each other. A transfer nip is formed by the upper roller 202a and the lower roller 202b being in pressure contact with each other. The secondary transfer section 202 causes the image created by the image creating section 200 and the sheet P to pass through the transfer nip, thereby transferring the image onto the sheet P.

At both ends of the upper roller 202a, a cam 202c and a press spring 202d are independently provided, respectively. The pressing springs 202d at both ends are pressed by the cam 202c at both ends, respectively, so that the pressure contact forces at both ends of the upper roller 202a and the lower roller 202b can be independently and continuously adjusted. With such a configuration, in the secondary transfer section 202, an optimally balanced pressure contact force can be set for both ends of the transfer member in accordance with the uneveness state of the sheet P. When the surfaces of the upper roller 202a and the lower roller 202b are formed of an elastic material such as sponge so as to follow the unevenness of the sheet P, the transfer performance can be secured even for larger unevenness.

The sheet conveyance section 24 includes a plurality of conveyance rollers 241 and a drive source thereof, a conveyance path 242, and the like and conveys the sheet P conveyed from the sheet feed device 1.

The storage section 25 is configured by, for example, a nonvolatile semiconductor memory, a hard disk drive, or the like. The storage section 25 stores various programs to be executed by the controller 21, parameters necessary for execution of processing by the programs, or data such as processing results. The storage section 25 stores input job information and the like. The job information is image data of a job and setting information of the job. Note that these data and the like may be stored in the RAM of the controller 21.

The operation display part 26 is configured by, for example, a liquid crystal display (LCD) with a touch screen. The operation display part 26 functions as the display part 261 and the operation part 262.

The display part 261 displays various operation screens, a state of an image, an operation status of each function, and the like according to a display control signal input from the controller 21.

The operation part 262 includes various operation keys such as a numeric keypad and a start key. The operation part 262 receives various input operation from a user and outputs an operation signal to the controller 21.

The communication section 27 is constituted by a communication control card such as a local area network (LAN) card. The communication section 27 exchanges various kinds of data with an external device (e.g., a personal computer) connected to a communication network such as a LAN or a wide area network (WAN).

The detection section 28 is provided on the upstream side in the sheet conveyance direction relative to the secondary transfer section 202 that transfers an image onto the sheet P. The detection section 28 detects the state of the sheet P, specifically, unevenness (change in thickness) in the sheet P, and outputs the result of detection to the controller 21.

FIG. 4 is a view illustrating an example of the detection section 28. Note that in the drawings of the present application, a level difference in the sheet P is denoted by a symbol ST.

The detection section 28 illustrated in FIG. 4 is disposed, for example, above the conveyance path 242 of the sheet P. The detection section 28 includes a plurality of distance sensors 280 arranged in the width direction of the sheet P. The width direction of the sheet P is a direction orthogonal to the sheet conveyance direction. The detection section 28 detects unevenness in the sheet P passing through the detection section 28, based on the distance from each distance sensor 280 to the sheet P. With such a configuration, the detection section 28 can detect unevenness parallel to the width direction of the sheet P, oblique unevenness, unevenness at a plurality of positions, and the like.

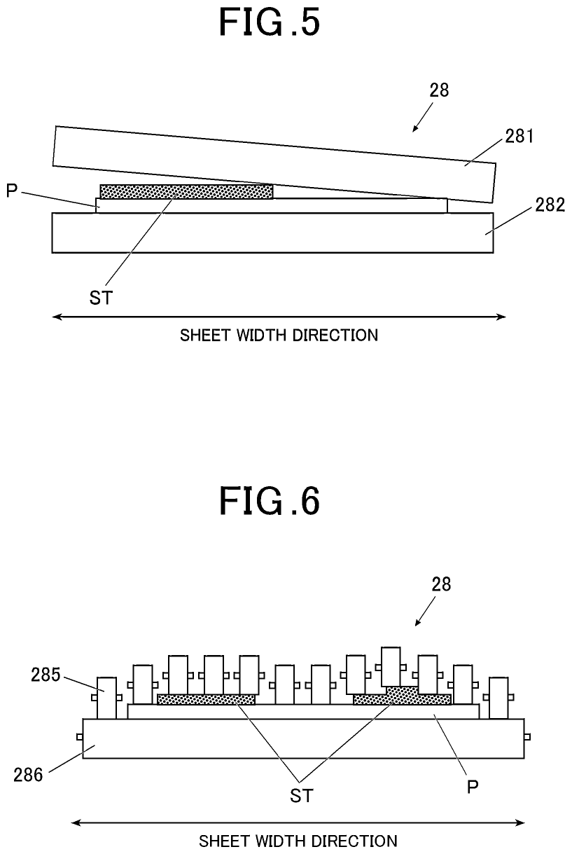

FIG. 5 is a view illustrating another example of the detection section 28.

The detection section 28 illustrated in FIG. 5 sandwiches the sheet P from both sides with the upper roller 281 and the lower roller 282 whose axial directions are the width direction of the sheet P, and detects the width-direction unevenness of the sheet P passing through the detection section 28 from the respective displacement amounts of both ends of the upper roller 281. With such a configuration, the detection section 28 can detect the unevenness of the sheet P in the width direction with a simple configuration. In addition, in a case where there is unevenness biased in the width direction of the sheet P, it is possible to accurately set the pressure balance between both ends of the roller of the secondary transfer section 202.

FIG. 6 is a view illustrating another example of the detection section 28.

The detection section 28 illustrated in FIG. 6 presses a plurality of rollers 285 arranged in the width direction of the sheet P against a roller 286 that presses the sheet P from the rear surface thereof, and detects the unevenness in the sheet P passing through the detection section 28 from the displacement amount of each roller 285. With such a configuration, even in a case where the behavior of the sheet P is unstable or in a case where there are unevenness on both surfaces of the sheet P, it is possible to accurately detect unevenness in the width direction of the sheet P.

The winding device 3 is an apparatus that winds the sheet P conveyed from the main body section 2 around a support shaft Y at a constant speed via a plurality of conveyance roller pairs. The winding operation of the winding device 3 is controlled by a controller 21 included in the main body section 2.

### Operation of Image Forming Apparatus 100

Next, transfer control processing based on a level difference of the sheet P in the image forming apparatus 100 will be described.

In a case where there is a level difference in the sheet used for image formation due to taping of roll sheet, cutting of the sheet on the seal side of the label sheet, or the like, when the level difference portion enters the transfer nip of the secondary transfer section, a transfer failure such as transfer deviation may occur due to an impact. In addition, the transfer member may be damaged, and an image defect may occur at the time of subsequent transfer.

To avoid this, conventionally, it has been proposed to separate a pair of rollers in the secondary transfer section in accordance with reaching of the level difference in the sheet.

However, when the transfer members are separated, it takes time until the transfer is restarted, and productivity decreases. Further, the impact of the separating operation is transmitted to the primary transfer section, so that the transfer deviation occurs. When the image creation is stopped in order to avoid the transfer deviation, there arises a problem that the relationship between the front and rear image positions is deviated or a waste sheet is generated in order to align the image positions.

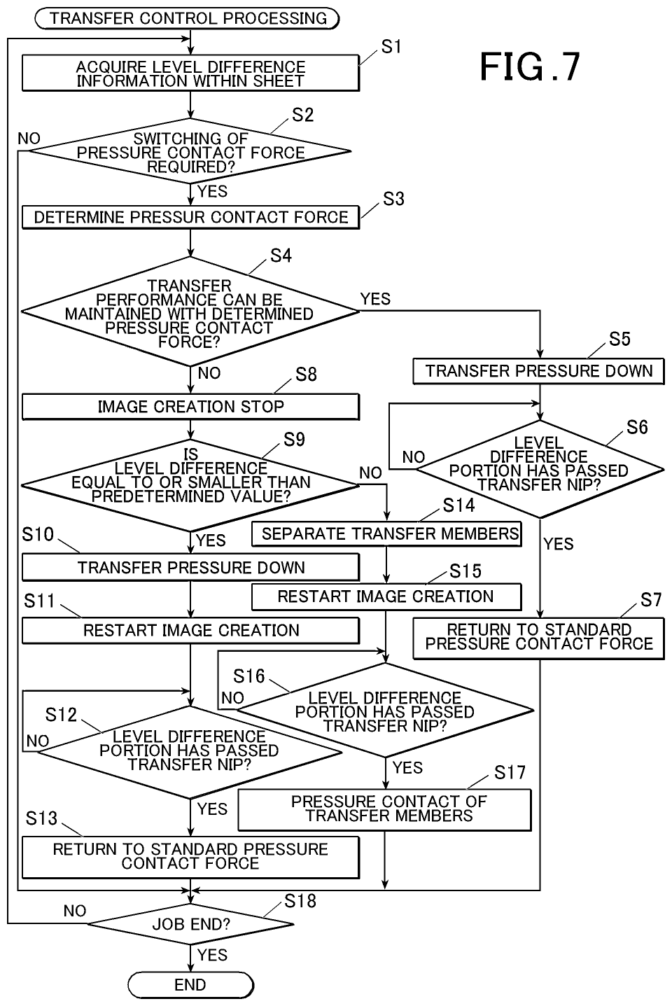

Therefore, when the image forming apparatus 100 is instructed to execute a job by receiving job information from the communication section 27, the image forming apparatus 100 executes an image forming process based on the job information and executes a transfer control process shown in FIG. 7.

In the image forming process based on the job information, first, the controller 21 brings the upper roller 202a and the lower roller 202b of the secondary transfer section 202 into pressure contact with the sheet P with a predetermined pressure contact force (standard pressure contact force). The standard pressure contact force referred to herein is a pressure contact force with which transfer performance can be ensured in a case where transfer is performed on the sheet P without a level difference. The standard pressure contact force may be selected from a plurality of values according to the thickness of the sheet P. Next, the controller 21 controls the sheet feed device 1, the image processing section 22, the image forming section 23, the sheet conveyance section 24, and the winding device 3 on the basis of the job information to form an image on the sheet P. The controller 21 controls the above-described sections to perform image formation until image formation based on all the job information is completed, that is, until the job is completed.

Further, the controller 21 executes a transfer control process shown in FIG. 7 in parallel with the image forming process based on the job information. The transfer control process is a process of changing the pressure contact force of the transfer member of the secondary transfer section 202 in the pressure contact state based on the level difference (the height of the level difference) in the sheet P in order to suppress the occurrence of damage to the transfer member and transfer failure.

Hereinafter, the transfer control processing will be described with reference to FIG. 7. The transfer control processing is executed by cooperation of the CPU and a program stored in the ROM of the controller 21.

First, the controller 21 causes the detection section 28 to detect the unevenness of the conveyed sheet P, and acquires level difference information on the sheet P from the detection result of the detection section 28 (step S1).

The level difference information is information indicating the position and height of a level difference present in the sheet P.

For example, the controller 21 stores the detection result (distance, displacement amount, and the like) of the detection section 28 in the RAM or the like in association with the time from the start of the feeding of the sheet P. Based on the stored detection result, the controller 21 acquires at least information on the position and height of the level difference in the area (image area) of the sheet P where the image is transferred. For example, the controller 21 acquires, as the height of the level difference, the difference between the detection result of the sheet P by the detection section 28 and the detection result when the sheet P having a standard thickness with no level difference is detected by the detection section 28. The detection result when the sheet P having a standard thickness without a level difference is detected by the detection section 28 may be obtained from the detection result of the sheet P being passed, or may be measured in advance and stored in the storage section 25. In a case where the detection result of the sheet P having a standard thickness without a level difference is obtained from the detection result of the sheet P being passed, the minimum value (in a case of the displacement amount) or the maximum value (in a case of the distance), the mode, or the like of the detection result of the sheet P being passed can be set as the detection result of the sheet P having a standard thickness without a level difference.

Next, the controller 21 determines, based on the acquired level difference information, whether switching of the pressure contact force of the secondary transfer section 202 is necessary (step S2).

For example, on the basis of the level difference information, the controller 21 determines whether or not a level difference exceeding a threshold value TH1 (first threshold value) exists in an area of the sheet P to which an image to be created by the image creating section 200 is to be transferred. The threshold value TH1 is a value at which, if the level difference (the height of the level difference) in the sheet P exceeds this value, the transfer member of the secondary transfer section 202 may be damaged by the pressure contact with the standard pressure contact force when the level difference portion enters the transfer nip, or transfer deviation may occur due to impact. The threshold values TH1 are values obtained experimentally or experientially. For example, the threshold value TH1 is a level difference of about 100 μm which is as thick as one sheet of paper having a normal basis weight 80 g/m². When determining that no level difference exceeding the threshold values TH1 exists in the area of the sheet P to which the image to be created by the image creating section 200 is to be transferred, the controller 21 determines that it is unnecessary to change the pressure contact force of the transfer member of the secondary transfer section 202. If the controller 21 determines that the level difference height exceeding the threshold values TH1 exists in the area of the sheet P where the image to be created by the image creating section 200 is to be transferred, the controller 21 determines that the switching of the pressure contact force of the transfer member of the secondary transfer section 202 is necessary.

If the controller 21 determines that switching of the pressure contact force of the secondary transfer section 202 is unnecessary (step S2; NO), the controller 21 proceeds to step S18.

That is, the controller 21 maintains the upper roller 202a and the lower roller 202b in pressure contact with each other with the predetermined pressure contact force (standard pressure contact force).

In a case where it is determined that the switching of the pressure contact force of the secondary transfer section 202 is necessary (step S2; YES), the controller 21 determines the pressure contact force of the transfer members of the secondary transfer section 202 based on the acquired level difference information (step S3).

For example, the storage section 25 stores a pressure contact force table in which the height of a level difference and an optimum pressure contact force for transferring an image onto a sheet including the level difference having the height are stored in association with each other. The optimum pressure contact force is, for example, a maximum pressure contact force that does not damage the transfer member of the secondary transfer section 202 and does not cause a transfer deviation due to an impact even when the level difference portion having the height enters the transfer nip. The optimum pressure contact force is the largest at the standard pressure contact force and becomes smaller as the level difference becomes larger. The controller 21 determines the pressure contact force of the transfer member of the secondary transfer section 202 based on the level difference information with reference to the pressure contact force table.

Note that the controller 21 preferably specifies the position of the level difference in the sheet width direction from the level difference information and determines the respective pressure contact forces of both ends of the transfer member of the secondary transfer section 202 on the basis of the position of the level difference. Accordingly, the controller 21 can change the pressure contact force of each of both ends of the transfer member of the secondary transfer section 202 according to the level difference in the sheet P.

Further, the pressure contact force table may be provided for each thickness of the sheet P. Then, the controller 21 may determine the pressure contact force based on the thickness of the sheet P and the level difference information.

Next, the controller 21 determines whether the transfer performance can be maintained with the determined pressure contact force (step S4).

Here, as described above, the optimum pressure contact force decreases as the level difference increases. However, when the level difference exceeds a threshold value TH2 (second threshold value; TH1<TH2), the pressure contact force corresponding to the level difference falls below the minimum pressure contact force capable of ensuring the transfer performance. Therefore, the transfer performance cannot be maintained. Therefore, when the level difference is equal to or smaller than the TH2, the controller 21 determines that the transfer performance can be maintained with the determined pressure contact force. When the level difference exceeds the threshold value TH2, it is determined that the transfer performance cannot be maintained with the determined pressure contact force.

Note that the minimum pressure contact force with which the transfer performance can be ensured may be stored in the storage section 25, and it may be determined whether or not the transfer performance can be maintained with the determined pressure contact force based on a comparison between the pressure contact force corresponding to the level difference in the sheet P and the minimum pressure contact force.

In a case where it is determined that the transfer performance can be maintained with the determined pressure contact force (step S4; YES), the controller 21 reduces the pressure contact force such that the pressure contact force of the transfer members of the secondary transfer section 202 becomes the determined pressure contact force when the level difference portion reaches the transfer nip of the secondary transfer section 202 (step S5).

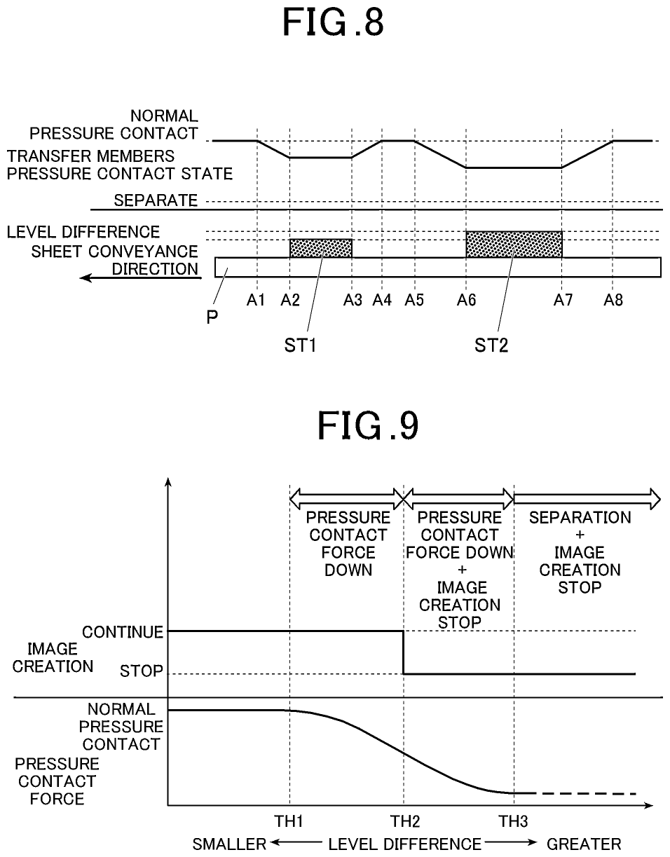

FIG. 8 is a diagram illustrating a change in a pressure contact state between a level difference (ST1, ST2) in the sheet P and the transfer member of the secondary transfer section 202. The “normal pressure contact” in FIGS. 8 and 9 indicates pressure contact with the above-described standard pressure contact force. As illustrated in FIG. 8, in consideration of the transition time from the standard pressure contact force to the determined pressure contact force in the secondary transfer section 202, the controller 21 implements the switching of the pressure contact force from the time of arrival at the point A1 where the leading end A2 of the level difference ST1 reaches the transfer nip before reaching the transfer nip by the transition time. When the rear end A3 of the level difference ST1 passes through the transfer nip, the controller 21 returns the pressure contact force to the standard pressure contact force. Similarly, the controller 21 executes the switching of the pressure contact force from the time of arrival at the point A5 at which the tip end A6 of the level difference ST2 reaches the transfer nip before reaching the transfer nip by the transition time. When the rear end A7 of the level difference ST2 passes through the transfer nip, the controller 21 returns the pressure contact force to the standard pressure contact force. Here, as shown in FIG. 8, the larger the level difference is, the larger the reduction width of the pressure contact force is, so that the switching of the pressure contact force is started earlier. As described above, by switching the pressure contact force in consideration of the transition time from the standard pressure contact force to the determined pressure contact force, the transfer to the level difference can be performed in a stable state.

Next, the controller 21 determines whether the level difference portion has passed through the transfer nip of the secondary transfer section 202 (step S6).

If the controller 21 determines that the level difference portion has not passed through the transfer nip of the secondary transfer section 202 (NO in step S6), the controller 21 repeats step S6.

When it is determined that the level difference portion has passed through the secondary transfer section 202 (step S6; YES), the controller 21 returns the pressure contact force of the transfer member of the secondary transfer section 202 to the standard pressure contact force (step S7), and proceeds to the process of step S18.

On the other hand, in step S4, when it is determined that the transfer performance cannot be maintained with the determined pressure contact force (step S4; NO), the controller 21 causes the image creating section 200 to stop the image creation so that the image does not pass through the secondary transfer section 202 at the timing when the level difference portion passes through the transfer nip of the secondary transfer section 202 (step S8).

Next, the controller 21 determines whether the height of the level difference is equal to or smaller than a predetermined value TH3 (step S9).

The predetermined value TH3 referred to herein is, for example, a value that, when the standard width of the sheet P is added to the predetermined value, gives the maximum sheet width that can be used in the image forming apparatus 100. TH1<TH2<TH3.

When determining that the height of the level difference is equal to or smaller than the predetermined value TH3 (step S9; YES), the controller 21 decreases the pressure contact force of the secondary transfer section 202 so that the pressure contact force becomes the determined pressure contact force when the level difference portion reaches the secondary transfer section 202 (step S10).

The processing in step S10 is the same as that described in the processing in step S5, and therefore, the description is cited.

The controller 21 causes the image creating section 200 to restart image creation such that the formed image passes through the secondary transfer section 202 at a predetermined timing after the level difference portion passes through the secondary transfer section 202 (step S11).

The controller 21 causes the image creating section 200 to restart image creation so that the formed image passes through the transfer nip of the secondary transfer section 202 at a predetermined timing after the level difference portion passes through the transfer nip of the secondary transfer section 202 based on the time required for image creation in the image creating section 200, the distance from the image creating section 200 to the secondary transfer section 202, the conveyance speed of the sheet P or the image, and the like.

Next, the controller 21 determines whether the level difference portion has passed through the transfer nip of the secondary transfer section 202 (step S12).

If the controller 21 determines that the level difference portion has not passed through the transfer nip of the secondary transfer section 202 (NO in step S12), the controller 21 repeats step S12.

If the controller 21 determines that the level difference portion has passed through the transfer nip of the secondary transfer section 202 (step S12; YES), the controller 21 returns the pressure contact force of the secondary transfer section 202 to the standard pressure contact force (step S13) and proceeds to the processing in step S18.

On the other hand, when determining in step S9 that the height of the level difference exceeds the predetermined value TH3 (step S9; NO), the controller 21 determines that an abnormality has occurred, and separates the transfer members of the secondary transfer section 202 (step S14).

Here, in a case where the height of the level difference exceeds a predetermined value TH3, even when the pressure contact force is reduced, damage occurs to the transfer member when the transfer member is caused to pass through the level difference in the transfer nip of the secondary transfer section 202. Therefore, when the height of the level difference exceeds a predetermined value TH3, the controller 21 determines that there is an abnormality and separates the transfer member of the secondary transfer section 202.

The height of the level difference allowable in the secondary transfer section 202 varies depending on the hardness and basis weight of the sheet P. Therefore, the controller 21 may change the predetermined value TH3 based on the sheet information of the sheet P stored in the storage section 25. The sheet information is information that can specify the hardness of the sheet, such as the type, material, and basis weight of the sheet, for example.

Next, the controller 21 causes the image creating section 200 to restart image creation such that the formed image passes through the nip of the secondary transfer section 202 at a predetermined timing after the level difference portion passes through the transfer nip of the secondary transfer section 202 (step S15).

The controller 21 causes the image creating section 200 to restart image creation such that the formed image passes through the transfer nip of the secondary transfer section 20 at a predetermined timing after the level difference portion passes through the secondary transfer section 20 based on the time required for image creation in the image creating section 200, the distance from the image creating section 200 to the secondary transfer section 202, the conveyance speed of the sheet P or the image, and the like.

Next, the controller 21 determines whether the level difference portion has passed through the transfer nip of the secondary transfer section 202 (step S16).

If the controller 21 determines that the level difference portion has not passed through the secondary transfer section 202 (step S16; NO), the controller 21 repeats step S16.

If the controller 21 determines that the level difference portion has passed through the secondary transfer section 202 (step S16; YES), the controller 21 causes the transfer members of the secondary transfer section 202 to pressure contact with each other with the standard pressure contact force (step S17) and proceeds to the processing in step S18.

In step S18, the controller 21 determines whether the job is completed (step S18).

If the controller 21 determines that the job is not completed (step S18; NO), the controller 21 returns to step S1 and repeats the processing from step S1 to step S18.

In a case where it is determined that the job is ended (step S18; YES), the controller 21 ends the transfer control process.

Note that the operation of the transfer control processing illustrated in FIG. 7 is, for example, a case where an image is also formed on a level difference of the sheet P such as label sheet cut into a necessary shape on release sheet. In a case where an image is not formed on a level difference such as a portion where sheets are connected by a tape, the switching of the pressure contact force of the secondary transfer section 202 is performed, but the image creation is stopped regardless of the height of the level difference.

FIG. 9 is a graph showing the relationship between the height of the level difference on the sheet surface, the pressure contact force of the transfer member of the secondary transfer section 202, and the continuation/stop of image creation in the transfer control process of FIG. 7. The horizontal axis of the graph represents level difference information (level difference height). In the vertical axis of the graph, the lower part indicates the pressure contact force of the transfer member of the secondary transfer section 202, and the upper part indicates continuation or stop of image creation. The dotted line of the graph indicating the pressure contact force indicates the separated state. In FIG. 9, for example, the TH1 is about 100 μm, the TH2 is about 400 μm, and the TH3 is about 1000 μm.

In FIG. 9, when the height of the level difference is up to the TH1, the transfer performance can be ensured with the standard pressure contact force, and there is no damage to the transfer member of the secondary transfer section 202 and no transfer deviation due to the impact when the level difference enters the transfer nip. Therefore, the switching of the pressure contact force of the transfer member of the secondary transfer section 202 is not performed, the standard pressure contact force is maintained, and the image creation by the image creating section 200 is continued.

When transfer is performed with the standard pressure contact force with the level difference height between TH1 and TH2, the transfer member of the secondary transfer section 202 may be damaged, or transfer deviation may occur due to an impact at the time of entry of the level difference into the transfer nip. Therefore, when the height of the level difference is between TH1 and TH2, the pressure contact force of the transfer member is switched to become lower according to the height of the level difference. Since the pressure contact force that corresponds to the level difference from TH1 to TH2 is a pressure contact force that can ensure transfer performance, image creation by the image creating section 200 is continued.

If the transfer is performed with the standard pressure contact force when the height of the level difference is between TH2 and TH3, the transfer member of the secondary transfer section 202 may be damaged, or the transfer deviation may occur due to the impact when the level difference enters the transfer nip. However, when the height of the level difference is between TH2 and TH3, the transfer performance cannot be ensured if the pressure contact force is reduced to a level at which damage to the transfer member and transfer deviation due to impact can be avoided. Therefore, when the height of the level difference is between TH2 and TH3, image creation by the image creating section 200 is stopped so that image creation is not performed on the level difference. However, when the transfer member of the secondary transfer section 202 is separated at the same time as the stop of the image creation, it takes time to restart the transfer, and the productivity decreases. Furthermore, an impact of the separation operation is transmitted to the primary transfer section, causing a transfer deviation, which leads to problems such as a shift in the relationship between the front and rear image positions and generation of waste sheet due to alignment of the image positions. Therefore, the transfer member is not separated when the height of the level difference is between TH2 and TH3, and the pressure contact state is maintained by reducing the pressure contact force.

When the height of the level difference exceeds TH3, even if the pressure contact force of the transfer member of the secondary transfer section 202 is set to the lowest level, damage to the transfer member cannot be avoided. Therefore, the transfer member of the secondary transfer section 202 is separated, and the image creation is also stopped.

That is, in the above-described transfer control process, for example, when the level difference is about 100 μm which is as thick as one sheet having a general basis weight 80 g/m², the controller 21 performs transfer without switching the pressure contact force of the transfer member of the secondary transfer section 202. If the level difference is from 100 μm to about 400 μm corresponding to one sheet of paper having a basis weight of about 400 g/m², the controller 21 continues image creation while reducing the pressure contact force of the transfer members of the secondary transfer section 202.

When the level difference is up to the maximum level difference allowable in the image forming apparatus 100, which is from 400 μm to 1000 μm, the controller 21 interrupts the image creation, but the pressure contact state continues.

In the case of a level difference exceeding 1000 μm which is the maximum level difference allowable in the image forming apparatus 100, the controller 21 separates the transfer member of the secondary transfer section 202.

In this way, in the transfer control processing, in a case where there is a level difference in the sheet P, unless the level difference exceeds the maximum level difference allowable in the image forming apparatus 100, the pressure contact state of the transfer member in the secondary transfer section 202 is maintained to reduce the pressure contact force, thereby suppressing the occurrence of damage to the transfer member and transfer failure. Therefore, while separation of the transfer member and stop of image creation are suppressed to the minimum, occurrence of damage to the transfer member and transfer failure can be suppressed.

### Modification Example 1

In the above embodiment, the level difference information is acquired based on the detection result of the sheet P by the detection section 28 in the transfer control processing in FIG. 7. However, the method of acquiring the level difference information is not limited to this example. For example, the level difference information of the sheet P may be stored in the storage section 25 in advance, and the controller 21 may read and acquire the level difference information of the sheet P from the storage section 25.

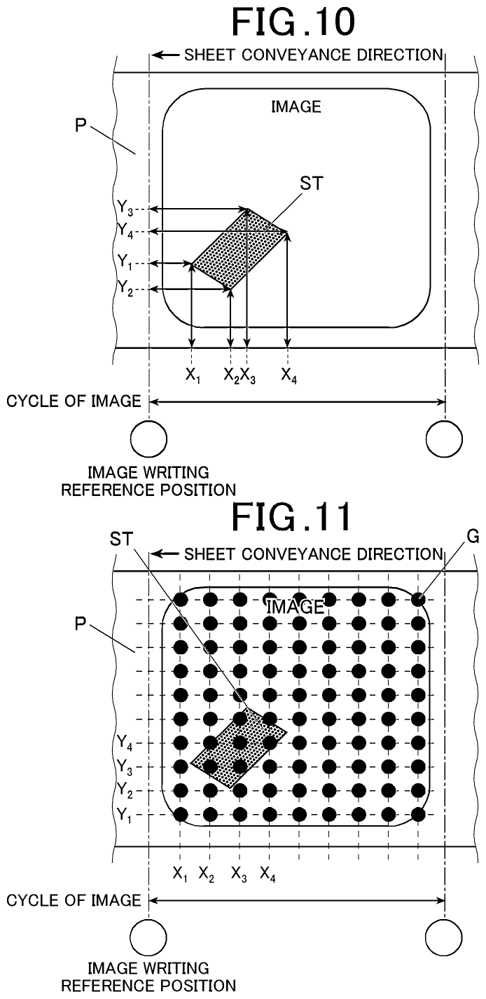

FIG. 10 is a diagram for explaining an example of level difference information stored in the storage section 25. In FIG. 10, a level difference is denoted by a reference sign ST. Note that in FIGS. 10 and 11, a circle indicates a writing reference position and a double-headed arrow indicates a cycle of an image.

The level difference information stored in the storage section 25 includes information on the positions of level differences and the heights of the level differences in the sheet P. The information on the position of the level difference is represented by a distance from the reference position. For example, for continuous sheet such as roll sheet, the end part of the image writing reference position and the lower end of the sheet in the sheet conveyance direction are set as the reference positions. In the case of a cut sheet (flat sheet), the sheet edge portion of the sheet leading edge and the sheet lower edge are set as the reference positions. As the information on the position of the level difference, distances from the reference position to the level difference in the conveyance direction (e.g., X1 to X4 in FIG. 10) and distances in a direction orthogonal to the conveyance direction (e.g., Y1 to Y4 in FIG. 10) are stored.

FIG. 11 is a diagram for explaining another example of the level difference information stored in the storage section 25. For example, information on the height of the level difference at each position of the intersection G of the grid arranged in the area corresponding to the writing cycle of the image from the above-described reference position is stored in the storage section 25 as the level difference information. The interval of the level difference information may be equal to the resolving power of the image, or may be an interval before and after the 5 mm followed by the transfer force of the secondary transfer section 202.

As described above, in the modification example 1, since the level difference information of the sheet P used for image formation is stored in the storage section 25, the transfer control process of FIG. 7 can be performed even when the image forming apparatus 100 is not provided with the detection section 28.

Note that the formats of the level difference information illustrated in FIG. 10 and FIG. 11 may be applied to the level difference information acquired from the detection result of the detection section 28 described in the above embodiment.

### Modification Example 2

In a case where the image forming apparatus 100 is connected to a post-processing apparatus, post-processing information on post-processing to be performed after transfer by the secondary transfer section 202 may be stored in the storage section 25. Based on the post-processing information, the controller 21 may determine the timing of restarting the image creation when the image creation in the image creating section 200 is stopped. The post-processing information includes information as to whether the post-processing is performed on the assumption that the cycle of the image is every designated length or the post-processing is performed in accordance with the image position in a case where the post-processing apparatus processes the continuous sheet.

For example, in steps S11 and S15 of FIG. 7, the controller 21 acquires, from the post-processing information stored in the storage section 25, information on whether the post-processing apparatus performs post-processing on the assumption that the cycle of images is every specified length or performs post-processing in accordance with the image position. In a case where the post-processing apparatus performs the post-processing on the assumption that the cycle of the image is set to each designated length, the controller 21 causes the image creating section 200 to restart the image creation at a timing at which the stop of the image creation for the designated length ends. In a case where the post-processing apparatus performs post-processing in accordance with the image position, the controller 21 causes the image creating section 200 to restart image creation so that the image is conveyed to the secondary transfer section 202 when the level difference portion passes through the secondary transfer section 202.

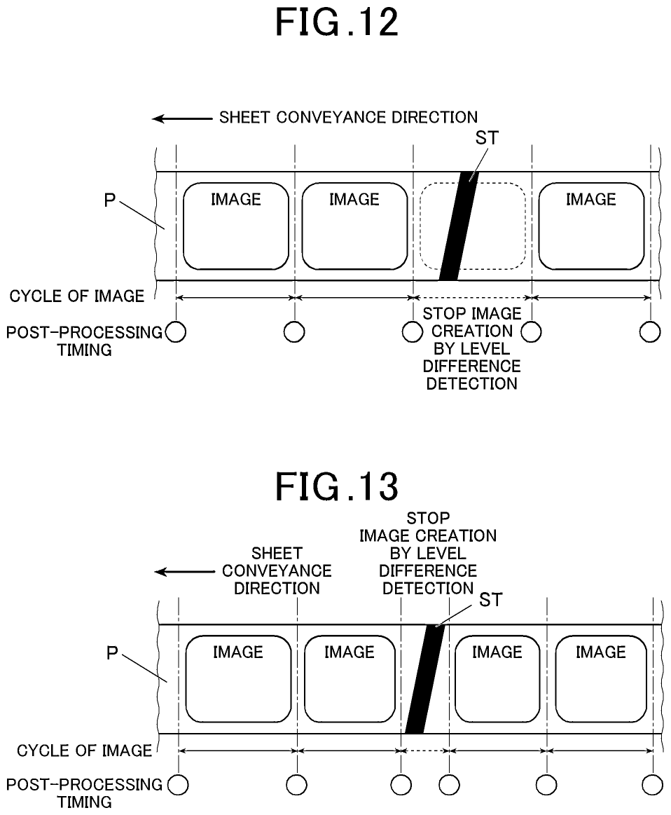

FIG. 12 is a diagram illustrating post-processing timing in a post-processing apparatus that performs post-processing on the assumption that the cycle of an image has a designated length, and an image creation stop period in modification example 2. In FIG. 12, a circle indicates timing of post-processing, and a double-headed arrow indicates a cycle of images. As illustrated in FIG. 12, the post-processing apparatus performs post-processing for each cycle (specified length) of an image. Therefore, in a case where the post-processing apparatus performs the post-processing on the assumption that the cycle of the image is set to the designated length, the controller 21 causes the image creating section 200 to restart the image creation at the timing at which the stop of the image creation for the length corresponding to the cycle of the image ends. In this way, it is possible to appropriately set the timing from the stop to the restart of the image creation due to the level difference in accordance with the timing of the post-processing, and to minimize the occurrence of waste sheet.

FIG. 13 is a diagram illustrating post-processing timing in a post-processing apparatus that performs post-processing in accordance with an image position and an image creation stop period in modification example 2. In FIG. 13, a circle indicates a timing of the post-processing, and a double-headed arrow indicates a cycle of the image. As illustrated in FIG. 13, the post-processing is performed in accordance with the image position in the post-processing apparatus.

Therefore, when the post-processing apparatus performs post-processing in accordance with the image position, the controller 21 causes the image creating section 200 to restart image creation at such a timing that the image arrives at the secondary transfer section 202 when the level difference portion passes the secondary transfer section 202 after the image creation is stopped. In this way, it is possible to minimize the timing from the stop to the restart of the image creation due to the level difference, and to minimize the occurrence of waste sheet.

As described above, according to the image forming apparatus 100, the controller 21 acquires the level difference information of the level difference in the sheet P, and changes the pressure contact force of the transfer member in the pressure contact state based on the acquired level difference information. Therefore, when there is a level difference in the sheet P, it is possible to suppress the occurrence of damage to the transfer member and transfer failure while maintaining the pressure contact state of the transfer member of the secondary transfer section 202.

For example, the image forming apparatus 100 includes a detection section 28 that is located upstream from the secondary transfer section 202 in the sheet conveyance direction and detects the state of the sheet P, and the controller 21 acquires the level difference information from the result of detection by the detection section 28. Therefore, the level difference information of the sheet P can be easily acquired.

For example, the detection section 28 includes a plurality of sensors (280 or 285) arranged in the width direction of the sheet P, and detects the unevenness in the width direction of the sheet P by the plurality of sensors (280 or 285). Therefore, partial unevenness in the width direction of the sheet P can be accurately detected.

Furthermore, the detection section 28 sandwiches the sheet P from both sides with the upper roller 281 and the lower roller 282 whose axial directions are the width direction of the sheet P, and detects the unevenness of the sheet P in the width direction from the displacement amount of both ends of the upper roller 281. Therefore, even in a case where the behavior of the sheet is unstable or in a case where there are unevenness on both surfaces of the sheet, it is possible to accurately detect the unevenness of the sheet.

Further, for example, the image forming apparatus 100 includes the storage section 25 that stores the level difference information of the sheet P, and the controller 21 acquires the level difference information from the storage section 25. Therefore, the controller 21 can acquire the level difference information without the detection section 28.

Further, the secondary transfer section 202 can independently adjust the pressure contact force of the transfer member at both ends in the width direction of the sheet P, and the controller 21 changes the pressure contact force of the transfer member of the secondary transfer section 202 at both ends in the width direction of the sheet P based on the acquired level difference information. Therefore, the transfer member can be brought into pressure contact with the sheet with a pressure contact force having an optimum balance in accordance with the state of the unevenness of the sheet.

In addition, the controller 21 changes the pressure contact force to be smaller as the level difference is larger. Therefore, it is possible to prevent problems such as transfer deviation due to damage or impact of the transfer member by reducing the pressure contact force as the level difference increases.

For example, the controller 21 brings the transfer member into pressure contact with a predetermined pressure contact force when the level difference is equal to or smaller than a first threshold value, and brings the transfer member into pressure contact with a pressure contact force smaller than the predetermined pressure contact force when the level difference exceeds the first threshold value. Therefore, when the level difference exceeds the first threshold value, the pressure contact force is reduced, so that it is possible to prevent defects such as transfer deviation due to damage or impact of the transfer member.

In a case where the level difference exceeds a second threshold value larger than the first threshold value, the controller 21 further causes the image creating section 200 to stop image creation. Therefore, it is possible to prevent an image in which the transfer performance cannot be maintained from being printed.

Furthermore, post-processing information on post-processing to be performed after the transfer by the secondary transfer section 202 is stored in the storage section 25, and when the image creation by the image creating section 200 is to be stopped, the controller 21 determines, based on the post-processing information, the timing at which the image creation by the image creating section 200 is to be restarted. Therefore, the timing from the stop to the restart of the image creation due to the level difference can be appropriately set in accordance with the post-processing, and the occurrence of waste sheet can be minimized.

Further, the controller 21 compares level difference information based on the detection result by the detection section 28 with a predetermined value, and determines that an abnormality has occurred when the level difference exceeds the predetermined value. Therefore, for example, when there is a level difference exceeding a predetermined value allowable in the image forming apparatus 100, it can be determined that an abnormality has occurred.

When the level difference exceeds a predetermined value, the controller 21 separates the transfer member of the secondary transfer section 202. Therefore, it is possible to prevent a level difference exceeding a predetermined value allowable in the image forming apparatus 100 from entering the transfer nip and damaging the transfer member.

Note that the above-described embodiment is a preferable example of the present invention and is not limited thereto.

For example, although the case where the present invention is applied to a roll of sheet has been described as an example in the above embodiment, the same effect can be achieved also in the case where the present invention is applied to a cut recording medium such as a cut sheet.

Besides, the detailed configuration and the detailed operation of the image forming apparatus can be appropriately modified without departing from the spirit and scope of the present invention.

According to the present invention, in an image forming apparatus, when a level difference is present on a sheet, it is possible to suppress occurrence of damage to a transfer member and transfer failure while maintaining a pressure contact state of the transfer member.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-202439, filed on Nov. 30, 2023, including description, claims, drawings and abstract is incorporated herein by reference.

What is claimed is:

1. An image forming apparatus comprising:
an image creator that creates an image;
a transferer that transfers the image created by the image creator onto a recording medium by causing the image and the recording medium to pass through a transfer nip formed by transfer members in a pressure contact state; and
a hardware processor that acquires level difference information of a level difference in the recording medium, and changes a pressure contact force of the transfer members in the pressure contact state based on the acquired level difference information.

2. The image forming apparatus according to claim 1, further comprising a detector that is located upstream of the transferer in a conveyance direction of the recording medium and detects a state of the recording medium, wherein the hardware processor acquires the level difference information from a detection result by the detector.

3. The image forming apparatus according to claim 2, wherein the detector detects unevenness in a width direction of the recording medium.

4. The image forming apparatus according to claim 3, wherein the detector includes a plurality of sensors arranged in the width direction of the recording medium, and detects the unevenness in the width direction of the recording medium with the plurality of sensors.

5. The image forming apparatus according to claim 3, wherein the detector sandwiches the recording medium from both sides with rollers whose axial directions are the width direction of the recording medium, and detects the unevenness in the width direction of the recording medium from displacement amounts of both ends of a roller among the rollers.

6. The image forming apparatus according to claim 1, further comprising a storage that stores the level difference information of the recording medium, wherein the hardware processor acquires the level difference information from the storage.

7. The image forming apparatus according to claim 1, wherein
the transferer is capable of independently adjusting a pressure contact force of each of ends of the transfer members in a width direction of the recording medium, and
the hardware processor changes the pressure contact force of each of the ends of the transfer members in the width direction of the recording medium, based on the level difference information.

8. The image forming apparatus according to claim 1, wherein the hardware processor changes the pressure contact force such that the pressure contact force decreases as the level difference increases.

9. The image forming apparatus according to claim 1, wherein the hardware processor brings the transfer members into pressure contact with a predetermined pressure contact force when the level difference is equal to or smaller than a first threshold value, and the hardware processor brings the transfer members into pressure contact with a pressure contact force smaller than the predetermined pressure contact force when the level difference exceeds the first threshold value.

10. The image forming apparatus according to claim 9, wherein the hardware processor further causes the image creator to stop image creation when the level difference exceeds a second threshold value that is greater than the first threshold value.

11. The image forming apparatus according to claim 10, further comprising a storage that stores post-processing information on post-processing to be performed after transferring by the transferer, wherein when the hardware processor causes the image creator to stop the image creation, the hardware processor determines, based on the post-processing information, a timing at which the image creation by the image creator is to be restarted.

12. The image forming apparatus according to claim 2, wherein the hardware processor compares a level difference based on the detection result by the detector with a predetermined value, and determines that an abnormality has occurred when the level difference exceeds the predetermined value.

13. The image forming apparatus according to claim 12, wherein the hardware processor causes the transfer members to separate when the level difference exceeds the predetermined value.

14. A non-transitory computer-readable storage medium storing a program for a computer of an image forming apparatus including: an image creator that creates an image; and a transferer that transfers the image created by the image creator onto a recording medium by causing the image and the recording medium to pass through a transfer nip formed by transfer members in a pressure contact state, the program causing the computer to acquire level difference information of a level difference in the recording medium, and change a pressure contact force of the transfer members in the pressure contact state based on the acquired level difference information.
